(19) United States
(12) Patent Application Publication
(10) Pub. No.: US 2025/0161140 A1
(43) Pub. Date: May 22, 2025

(54) NEGATIVE PRESSURE MASSAGE DEVICE AND USING METHOD THEREOF

(71) Applicant: BIBOTING INTERNATIONAL CO., LTD., TAOYUAN CITY (TW)

(72) Inventor: Pei-En LEE, New Taipei City (TW)

(21) Appl. No.: 18/514,944

(22) Filed: Nov. 20, 2023

(51) Int. Cl. A61H 9/00

(52) U.S. Cl. CPC A61H 9/0057; A61H 2201/1215; A61H 2201/1246

(57) ABSTRACT

A negative pressure massage device includes: a vacuum pump communicating to an open end; a first solenoid valve communicating to the vacuum pump and the open end; a second solenoid valve communicating to the vacuum pump, the open end, and the first solenoid valve; a third solenoid valve communicating to the vacuum pump, the open end, the first solenoid valve, and the second solenoid valve; and a control board electrically connected to the vacuum pump, the first solenoid valve, the second solenoid valve, and the third solenoid valve. When any one of the first solenoid valve, the second solenoid valve, and the third solenoid valve is opened, the vacuum pump maintains communicating with the open end.

### BACKGROUND OF THE DISCLOSURE

### Technical Field

The present disclosure relates to a negative pressure massage device and using method thereof, which are applied in massage.

### Description of Related Art

In recent years, with the development of industrialization and informatization, people generally lack for exercise. Whether we are using computers, watching TV, playing video games, or sitting on airplanes for a long time, we often maintain poor posture. These sitting postures often tighten the muscles of our head, neck, shoulders, chest, hips, or abdomen, leading to tension headaches and neck and shoulder pain. Such a condition may also hinder normal blood circulation in the brain, making people often feel tired and have difficulty concentrating.

In order to let people have full relaxation and rest in their limited free time, many kinds of massage equipment have appeared on the market, such as the negative pressure massage device. Generally, the negative pressure massage device includes a system unit, a hose, and a vacuum cup. The two ends of the hose are connected to the system unit and the vacuum cup respectively. The user may control the pressure in the vacuum cup through the system unit to achieve a relaxation effect of massage.

However, the general negative pressure massage equipment does not have the function of adjusting pressure. Due to the different physiological structures and organ positions of various parts of the human body, the general negative pressure massage equipment is difficult to optimally adapt to different parts of the human body, and also difficult to adapt to different massage objects, such as the elderly and children, men and women, etc. This not only brings operational troubles but also increases the cost of manufacturing a plurality of sets of equipment.

In view of this, how to design a negative pressure massage device and using method thereof that may adjust pressure is actually one of the current problems that need to be solved urgently.

### SUMMARY OF THE DISCLOSURE

The present disclosure provides the negative pressure massage device and using method thereof. Compared to the related-art of the negative pressure massage device, which does not have the function of adjusting pressure, the present disclosure of the negative pressure massage device and using method thereof may adjust the pressure. The present disclosure of the negative pressure massage device and using method thereof may optimally adapt to different parts of the human body, and also adapt to different massage targets, such as the elderly and children, men and women, etc. It not only brings operational convenience but also reduces the cost of manufacturing a plurality of sets of equipment.

The present disclosure provides a negative pressure massage device, including: a vacuum pump, communicating to an open end; a first solenoid valve, communicating to the vacuum pump and the open end; a second solenoid valve, communicating to the vacuum pump, the open end, and the first solenoid valve; a third solenoid valve, communicating to the vacuum pump, the open end, the first solenoid valve, and the second solenoid valve; and a control board, electrically connected to the vacuum pump, the first solenoid valve, the second solenoid valve, and the third solenoid valve; wherein, when any one of the first solenoid valve, the second solenoid valve, and the third solenoid valve is turned on, the vacuum pump is configured to maintain a communicating with the open end.

In some embodiments, when the first solenoid valve is turned on and the second solenoid valve and the third solenoid valve are turned off, the vacuum pump is configured to maintain the communicating with the open end.

In some embodiments, when the first solenoid valve and the second solenoid valve are turned on and the third solenoid valve is turned off, the vacuum pump is configured to maintain the communicating with the open end.

In some embodiments, when the first solenoid valve, the second solenoid valve, and the third solenoid valve are turned on simultaneously, the vacuum pump is configured to maintain the communicating with the open end.

In some embodiments, a first flow, which is generated when the first solenoid valve is turned on, is equal to a second flow, which is generated when the second solenoid valve is turned on.

In some embodiments, the first flow, the second flow, and a third flow, which is generated when the third solenoid valve is turned on, are equal to one another.

In some embodiments, the negative pressure massage device, further including: a fourth solenoid valve, communicating to the vacuum pump, the open end, the first solenoid valve, the second solenoid valve, and the third solenoid valve, and electrically connected to the control board; wherein, when the first solenoid valve, the second solenoid valve, the third solenoid valve, and the fourth solenoid valve are turned on simultaneously, the vacuum pump is configured to maintain the communicating with the open end.

In some embodiments, the first flow, the second flow, the third flow, and a fourth flow, which is generated when the fourth solenoid valve is turned on, are equal to one another.

A negative pressure massage device including: a vacuum pump, communicating to an open end; a first solenoid valve, communicating to the vacuum pump and the open end; a second solenoid valve, communicating to the vacuum pump, the open end, and the first solenoid valve; a third solenoid valve, communicating to the vacuum pump, the open end, the first solenoid valve, and the second solenoid valve; and a control board, electrically connected to the vacuum pump, the first solenoid valve, the second solenoid valve, and the third solenoid valve; wherein, the vacuum pump, the first solenoid valve, the second solenoid valve, and the third solenoid valve are parallelly disposed with one another.

In some embodiments, when the first solenoid valve is turned on and the second solenoid valve and the third solenoid valve are turned off, the vacuum pump is configured to maintain a communicating with the open end.

In some embodiments, when the first solenoid valve and the second solenoid valve are turned on and the third solenoid valve is turned off, the vacuum pump is configured to maintain the communicating with the open end.

In some embodiments, when the first solenoid valve, the second solenoid valve, and the third solenoid valve are turned on simultaneously, the vacuum pump is configured to maintain the communicating with the open end.

In some embodiments, a first flow, which is generated when the first solenoid valve is turned on, is equal to a second flow, which is generated when the second solenoid valve is turned on.

In some embodiments, the first flow, the second flow, and a third flow, which is generated when the third solenoid valve is turned on, are equal to one another.

In some embodiments, the negative pressure massage device, further including: a fourth solenoid valve, communicating to the vacuum pump, the open end, the first solenoid valve, the second solenoid valve, and the third solenoid valve, and electrically connected to the control board; wherein, when the first solenoid valve, the second solenoid valve, the third solenoid valve, and the fourth solenoid valve are turned on simultaneously, the vacuum pump is configured to maintain the communicating with the open end.

In some embodiments, the first flow, the second flow, the third flow, and a fourth flow, which is generated when the fourth solenoid valve is turned on, are equal to one another.

A using method of a negative pressure massage device, the using method including: turning on a vacuum pump of the negative pressure massage device; generating, by the vacuum pump, a first negative pressure value at an open end; turning on a first solenoid valve of the negative pressure massage device; generating, by the first solenoid valve, a first flow and generating a second negative pressure value at the open end; turning on a second solenoid valve of the negative pressure massage device; and generating, by the second solenoid valve, a second flow and generating a third negative pressure value at the open end; wherein, the first flow is equal to the second flow.

In some embodiments, when the first solenoid valve and the second solenoid valve are turned on or turned off, the vacuum pump communicates with the open end, and the vacuum pump is configured to maintain a turn-on state.

In some embodiments, the using method, further including: turning on a third solenoid valve of the negative pressure massage device; and generating, by the third solenoid valve, a third flow and generating a fourth negative pressure value at the open end; wherein, the first flow, the second flow, and the third flow are equal to one another.

In some embodiments, when the first solenoid valve, the second solenoid valve, and the third solenoid valve are turned on or turned off, the vacuum pump communicates with the open end, and the vacuum pump is configured to maintain a turn-on state.

In summary, comparing the negative pressure massage device and using method thereof of the present disclosure with the negative pressure massage equipment of the related-art, the negative pressure massage equipment of the related-art is difficult to optimally adapt to different parts of the human body and difficult to adapt to different massage targets, such as the elderly and children, men and women, etc. In the negative pressure massage device of the present disclosure, the user first turns on the main power of the negative pressure massage device. Next, the control board may be used to control the turning on of the vacuum pump and the turning on or turning off of the first solenoid valve, the second solenoid valve, and the third solenoid valve. The flow may be controlled through individually turning on the first solenoid valve, the second solenoid valve, or the third solenoid valve, or through simultaneously turning on the first solenoid valve and the second solenoid valve, the first solenoid valve and the third solenoid valve, or the second solenoid valve and the third solenoid valve, or through simultaneously turning on the first solenoid valve, the second solenoid valve, and the third solenoid valve to achieve more diverse negative pressures, which is changing with time, and achieve different massage effects and purposes. Further, the technical problem in the related-art of difficult to optimally adapting to the massage status of various parts of the human body or the object being massaged may be solved, and the purpose of saving costs and improving usage efficiency may also be achieved. Furthermore, the operation method of the negative pressure massage device of the present disclosure, may be simplified by making the first flow, the second flow, and the third flow be equal to one another. For example, the user does not need to adjust the flow rate of each solenoid valve, and may simply turn on or turn off each solenoid valve to combine different flow requirements. In addition, regardless of whether the first solenoid valve, the second solenoid valve, and the third solenoid valve are turning on or turning off, the vacuum pump may remain communicating to the open end and continuing to operate. That may avoid the vacuum pump from generating a negative pressure at the open end when the vacuum pump is turned on, and result in energy waste.

### BRIEF DESCRIPTION OF THE DRAWINGS

FIG. 1 is a system framework diagram of the negative pressure massage device in accordance with a first embodiment of the present disclosure.

FIG. 2 is a system framework diagram of the negative pressure massage device in accordance with a second embodiment of the present disclosure.

FIG. 3A and FIG. 3B are the flowcharts of the using method of the negative pressure massage device in accordance with the present disclosure.

### DETAILED DESCRIPTION

The technical contents of this disclosure will become apparent with the detailed description of embodiments accompanied with the illustration of related drawings as follows. It is intended that the embodiments and drawings disclosed herein are to be considered illustrative rather than restrictive.

As used in the present disclosure, terms such as “first”, “second”, “third”, “fourth”, and “fifth” are employed to describe various elements, components, regions, layers, and/or parts.

These terms should not be construed as limitations on the mentioned elements, components, regions, layers, and/or parts. Instead, they are used merely for distinguishing one element, component, region, layer, or part from another. Unless explicitly indicated in the context, the usage of terms such as “first”, “second”, “third”, “fourth”, and “fifth” does not imply any specific sequence or order.

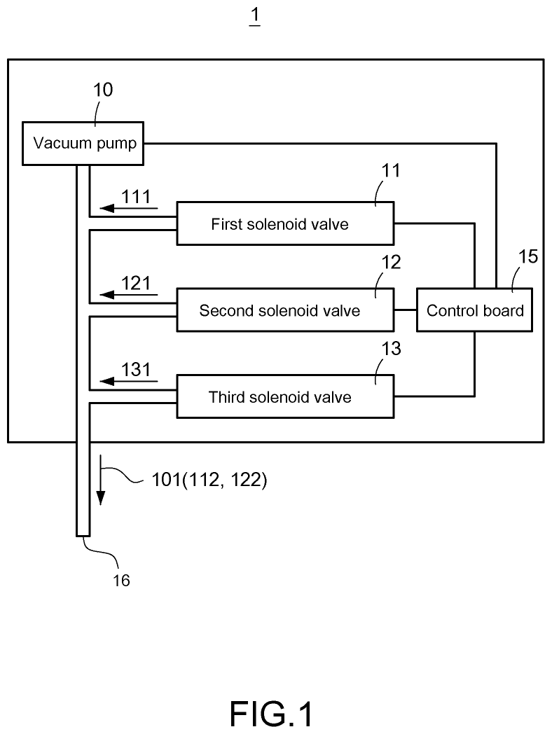

FIG. 1 is a system framework diagram of the negative pressure massage device 1 in accordance with a first embodiment of the present disclosure. Please refer to FIG. 1, the negative pressure massage device 1 of the first embodiment includes a vacuum pump 10, a first solenoid valve 11, a second solenoid valve 12, a third solenoid valve 13, and a control board 15.

The vacuum pump 10 communicates with an open end 16. When the vacuum pump 10 is turned on, the first negative pressure value 101 may be generated at the open end 16. The first negative pressure value 101 is the difference value between the atmospheric pressure of the environment and the pressure at the open end 16. When the vacuum pump 10 is turned on, the first negative pressure value 101 is a positive value. When the pressure at the open end 16 is smaller, the first negative pressure value 101 is larger. When the vacuum pump 10 is turned off, the pressure at the open end 16 is the same as the atmospheric pressure of the environment. Depending on different definitions, the negative pressure value may also be a negative value, here is not intended to be limiting.

The first solenoid valve 11 communicates with the vacuum pump 10 and the open end 16. When the first solenoid valve 11 is opened, the air outside the negative pressure massage device 1 may flow in through the first solenoid valve 11. As a result, the pressure at the open end 16 may be adjusted. The amount of air flowing into the first solenoid valve 11 per unit time is the first flow 111. The amount of air may be defined by volume, mass, or other definitions. When the first solenoid valve 11 is disposed with a larger cross-sectional area, the first flow 111 is larger. When the first solenoid valve 11 is turned off, the air outside the negative pressure massage device 1 may not flow in through the first solenoid valve 11.

The second solenoid valve 12 communicates with the vacuum pump 10, the open end 16, and the first solenoid valve 11. When the second solenoid valve 12 is turned on, the air outside the negative pressure massage device 1 may flow in through the second solenoid valve 12. As a result, the pressure at the open end 16 may be adjusted. The amount of air flowing into the second solenoid valve 12 per unit time is the second flow 121. The amount of air may be defined by volume, mass, or other definitions. When the second solenoid valve 12 is disposed with a larger cross-sectional area, the second flow 121 is larger. When the second solenoid valve 12 is turned off, the air outside the negative pressure massage device 1 may not flow in through the second solenoid valve 12.

The third solenoid valve 13 communicates with the vacuum pump 10, the open end 16, the first solenoid valve 11, and the second solenoid valve 12. When the third solenoid valve 13 is opened, the air outside the negative pressure massage device 1 may flow in through the third solenoid valve 13. As a result, the pressure at the open end 16 may be adjusted. The amount of air flowing into the third solenoid valve 13 per unit time is the third flow 131. The amount of air may be defined by volume, mass, or other definitions. When the third solenoid valve 13 is disposed with a larger cross-sectional area, the third flow 131 is larger. When the third solenoid valve 13 is turned off, the air outside the negative pressure massage device 1 may not flow in through the third solenoid valve 13.

It is worth mentioning that the vacuum pump 10, the first solenoid valve 11, the second solenoid valve 12, and the third solenoid valve 13 are parallelly disposed with one another. When any one of the first solenoid valve 11, the second solenoid valve 12, and the third solenoid valve 13 is turned on, the vacuum pump 10 is configured to maintain a communicating with the open end 16. That is, when the first solenoid valve 11 is turned on or turned off, the communication between the vacuum pump 10 and the open end 16 is not being blocked. Similarly, when the second solenoid valve 12 is turned on or turned off, the communication between the vacuum pump 10 and the open end 16 is not being blocked. Similarly, when the third solenoid valve 13 is turned on or turned off, the communication between the vacuum pump 10 and the open end 16 is not being blocked. In other words, the vacuum pump 10 may remain communicating to the open end 16 and continuing to operate, regardless of whether the first solenoid valve 11, the second solenoid valve 12, and the third solenoid valve 13 are turned on or turned off.

The control board 15 is electrically connected to the vacuum pump 10, the first solenoid valve 11, the second solenoid valve 12, and the third solenoid valve 13. For example, the control board 15 may control at least one of the vacuum pump 10, the first solenoid valve 11, the second solenoid valve 12, and the third solenoid valve 13 to be turning on or turning off.

In some embodiments, when the first solenoid valve 11 is turned on and the second solenoid valve 12 and the third solenoid valve 13 are turned off, the vacuum pump 10 is configured to maintain the communication with the open end 16. In other embodiments, when the first solenoid valve 11 and the second solenoid valve 12 are turned on and the third solenoid valve 13 is turned off, the vacuum pump 10 is configured to maintain the communication with the open end 16. In still other embodiments, when the first solenoid valve 11, the second solenoid valve 12, and the third solenoid valve 13 are turned on simultaneously, the vacuum pump 10 is configured to maintain the communication with the open end 16. As a result, the operating modes of the negative pressure massage device 1 may be increased.

It is worth mentioning that a first flow 111, which is generated when the first solenoid valve 11 is turned on, is equal to a second flow 121, which is generated when the second solenoid valve 12 is turned on. Furthermore, the first flow 111, the second flow 121, and a third flow 131, which is generated when the third solenoid valve 13 is turned on, are equal to one another, here is not intended to be limiting. In other words, the first flow 111, the second flow 121 and the third flow 131 may all be equal.

In summary, comparing the negative pressure massage device 1 of the present embodiment with the negative pressure massage equipment of the related-art, the negative pressure massage equipment of the related-art is difficult to optimally adapt to different parts of the human body and difficult to adapt to different massage targets, such as the elderly and children, men and women, etc. In the negative pressure massage device 1 of the embodiment, the user first turns on the main power of the negative pressure massage device 1. Next, the control board 15 may be used to control the turning on of the vacuum pump 10 and the turning on or turning off of the first solenoid valve 11, the second solenoid valve 12, and the third solenoid valve 13. The flow may be controlled through individually turning on the first solenoid valve 11, the second solenoid valve 12, or the third solenoid valve 13, or through simultaneously turning on the first solenoid valve 11 and the second solenoid valve 12, the first solenoid valve 11 and the third solenoid valve 13, or the second solenoid valve 12 and the third solenoid valve 13, or through simultaneously turning on the first solenoid valve 11, the second solenoid valve 12, and the third solenoid valve 13 to achieve more diverse negative pressures, which is changing with time, and achieve different massage effects and purposes. Further, the technical problem in the related-art of difficult to optimally adapting to the massage status of various parts of the human body or the object being massaged may be solved, and the purpose of saving costs and improving usage efficiency may also be achieved. Furthermore, the operation method of the negative pressure massage device 1 of the present disclosure, may be simplified by making the first flow 111, the second flow 121, and the third flow 131 be equal to one another. For example, the user does not need to adjust the flow rate of each solenoid valve, and may simply turn on or turn off each solenoid valve to combine different flow requirements. In addition, regardless of whether the first solenoid valve 11, the second solenoid valve 12, and the third solenoid valve 13 are turning on or turning off, the vacuum pump 10 may remain communicating to the open end 16 and continuing to operate. That may avoid the vacuum pump 10 from generating a negative pressure at the open end 16 when the vacuum pump 10 is turned on, and result in energy waste.

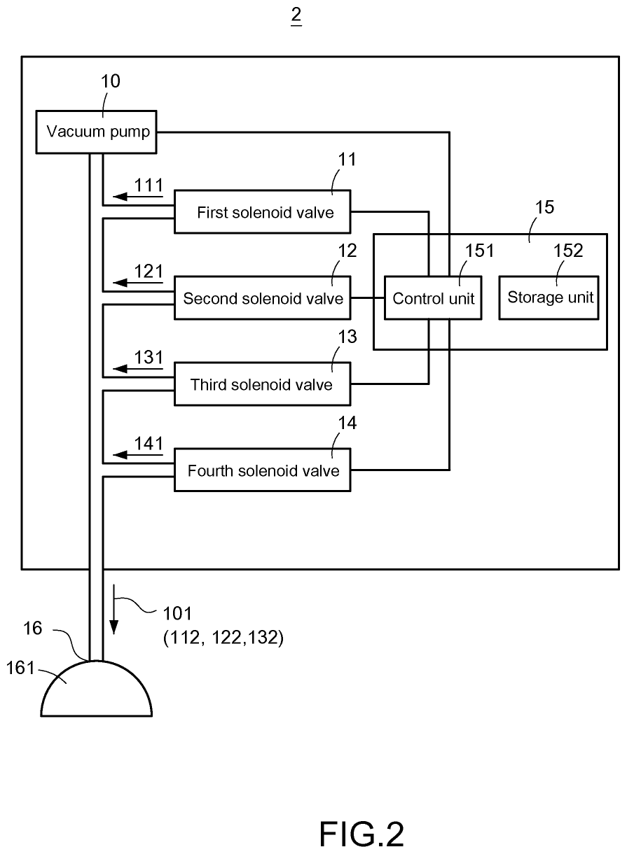

FIG. 2 is a system framework diagram of the negative pressure massage 2 device in accordance with a second embodiment of the present disclosure. Please refer to FIG. 2, the difference between the negative pressure massage device 2 of the second embodiment and the negative pressure massage device 1 of the first embodiment is that the negative pressure massage device 2 further includes the fourth solenoid valve 14 and the cup body 161. The control board 15 further includes the control unit 151 and the storage unit 152. The vacuum pump 10, the first solenoid valve 11, the second solenoid valve 12, the third solenoid valve 13, and the control board 15 of the negative pressure massage device 2 of the second embodiment are similar to the vacuum pump 10, the first solenoid valve 11, the second solenoid valve 12, the third solenoid valve 13 and the control board 15, of the negative pressure massage device 1 of the first embodiment. Therefore, here is omitted for brevity.

The fourth solenoid valve 14 communicates with the vacuum pump 10, the open end 16, the first solenoid valve 11, the second solenoid valve 12, and the third solenoid valve 13, and is electrically connected to the control board 15. When the fourth solenoid valve 14 is turned on, the air outside the negative pressure massage device 2 may flow in through the fourth solenoid valve 14. As a result, the pressure at the open end 16 may be adjusted. The amount of air flowing into the fourth solenoid valve 14 per unit time is the fourth flow 141. The amount of air may be defined by volume, mass, or other definitions. When the fourth solenoid valve 14 is disposed with a larger cross-sectional area, the fourth flow 141 is larger. When the fourth solenoid valve 14 is turned off, the air outside the negative pressure massage device 2 may not flow in through the fourth solenoid valve 14.

When the first solenoid valve 11, the second solenoid valve 12, the third solenoid valve 13, and the fourth solenoid valve 14 are turned on simultaneously, the vacuum pump 10 is configured to maintain the communicating with the open end 16. That is, when the first solenoid valve 11 is turned on or turned off, the communication between the vacuum pump 10 and the open end 16 is not being blocked. Similarly, when the second solenoid valve 12 is turned on or turned off, the communication between the vacuum pump 10 and the open end 16 is not being blocked. Similarly, when the third solenoid valve 13 is turned on or turned off, the communication between the vacuum pump 10 and the open end 16 is not being blocked. Similarly, when the fourth solenoid valve 14 is turned on or turned off, the communication between the vacuum pump 10 and the open end 16 is not being blocked. In other words, the vacuum pump 10 may remain communicating to the open end 16 and continuing to operate, regardless of whether the first solenoid valve 11, the second solenoid valve 12, the third solenoid valve 13, and the fourth solenoid valve 14 are turned on or turned off.

The cup body 161 is connected to the open end 16, and the cup body 161 may have a three-dimensional curved surface shape, such as a hemispherical shape or a semi-ellipsoidal shape. Here is not intended to be limiting the present disclosure. The material of the cup body 161 may be plastic or glass, and here is not intended to be limiting the present disclosure.

The control unit 151 may include, for example, a sensor integrated circuit, a micro control unit (MCU), a microprocessor unit (MPU), a central process unit, (CPU), an application specific integrated circuit (ASIC), a digital signal processor (DSP), a graphics processing unit (GPU), a field programmable gate array (FPGA), a system on chip (SoC), or other applicable chips, but here is not intended to limit the present disclosure. The control unit 151 is electrically connected to the vacuum pump 10, the first solenoid valve 11, the second solenoid valve 12, the third solenoid valve 13, and the fourth solenoid valve 14. The control unit 151 may control at least one of the vacuum pump 10, the first solenoid valve 11, the second solenoid valve 12, the third solenoid valve 13, and the fourth solenoid valve 14 to be turning on or turning off. The storage unit 152 is electrically connected to the control unit 151. The storage unit 152 stores the control parameters. The control unit 151 turns on or turns off at least one of the vacuum pump 10, the first solenoid valve 11, the second solenoid valve 12, the third solenoid valve 13, and the fourth solenoid valve 14 according to the control parameters.

In some embodiment, the first flow 111, the second flow 121, the third flow 131, and a fourth flow 141, which is generated when the fourth solenoid valve 14 is turned on, are equal to one another. Here is not intended to be limiting.

In summary, comparing the negative pressure massage device 2 of the embodiment with the negative pressure massage equipment of the related-art, the negative pressure massage equipment of the related-art is difficult to optimally adapt to different parts of the human body and difficult to adapt to different massage targets, such as the elderly and children, men and women, etc. In the negative pressure massage device 2 of the embodiment, the user may first place the cup body 161 on the part to be massaged, and then turn on the main power of the negative pressure massage device 2.

Next, the control unit 151 may be used to control the turning on of the vacuum pump 10 according to the control parameters stored in the storage unit 152. The control unit 151 controls the turning on or turning off of the first solenoid valve 11, the second solenoid valve 12, the third solenoid valve 13, and the fourth solenoid valve 14.

The control unit 151 may turn on any one or both or three or all of the first solenoid valve 11, the second solenoid valve 12, the third solenoid valve 13, and the fourth solenoid valve 14 to control flow to achieve more diverse negative pressures, which is changing with time, and achieve different massage effects and purposes. Further, the technical problem in the related-art of difficult to optimally adapting to the massage status of various parts of the human body or the object being massaged may be solved, and the purpose of saving costs and improving usage efficiency may also be achieved. Furthermore, the operation method of the negative pressure massage device 2 of the present disclosure, may be simplified by making the first flow 111, the second flow 121, the third flow 131, and the fourth flow 141 be equal to one another. For example, the user does not need to adjust the flow rate of each solenoid valve, and may simply turn on or turn off each solenoid valve to combine different flow requirements.

In addition, regardless of whether the first solenoid valve 11, the second solenoid valve 12, the third solenoid valve 13, and the fourth flow 141 are turning on or turning off, the vacuum pump 10 may remain communicating to the open end 16 and continuing to operate. That may avoid the vacuum pump 10 from generating negative pressure at the open end 16 when the vacuum pump 10 is turned on, and result in energy waste. Moreover, by disposing of the cup body 161 may adapt to the shape of the human body, making the massage process more comfortable.

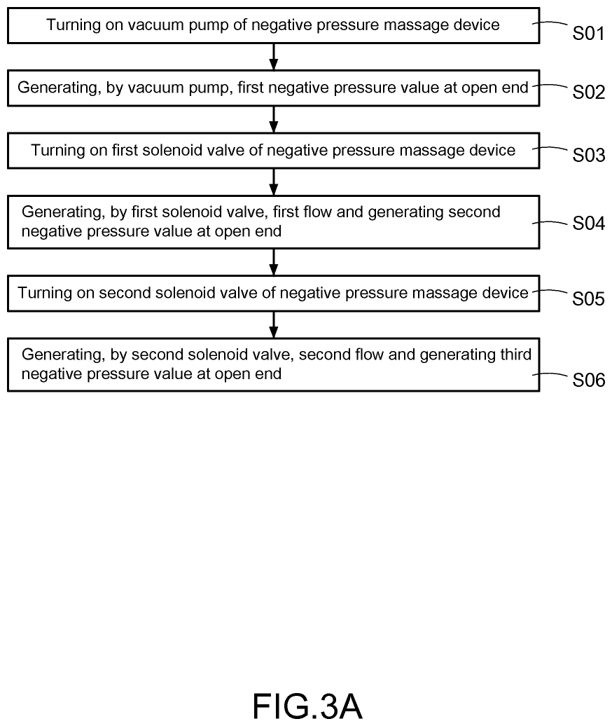

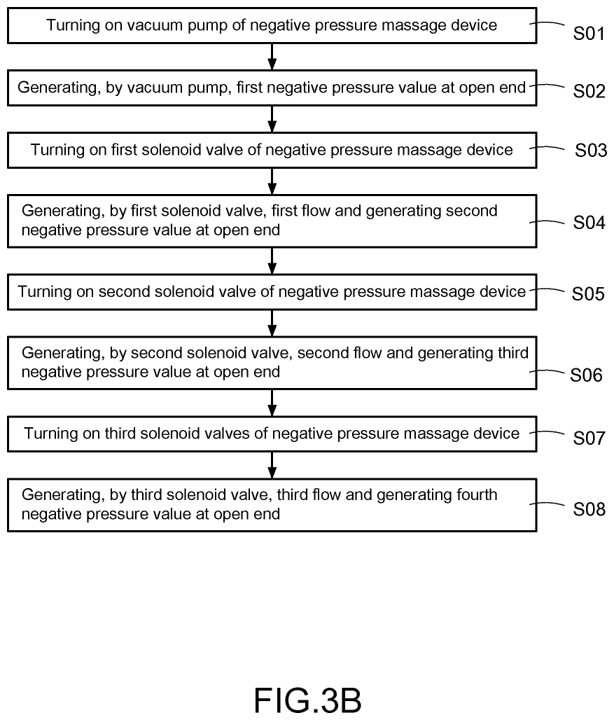

FIG. 3A is the step chart diagram of the using method of the negative pressure massage device 1 in accordance with the present disclosure. Please refer to FIG. 3A. The step S01 is turning on a vacuum pump of the negative pressure massage device. The step S02 is generating, by the vacuum pump, a first negative pressure value at an open end. The step S03 is turning on a first solenoid valve of the negative pressure massage device. The step S04 is generating, by the first solenoid valve, a first flow and generating a second negative pressure value at the open end. The step S05 is turning on a second solenoid valve of the negative pressure massage device. The step S06 is generating, by the second solenoid valve, a second flow and generating a third negative pressure value at the open end.

Please refer to FIG. 1 and FIG. 3A, before the step S01, the user first turns on the main power of the negative pressure massage device 1. Next, the user may control the negative pressure massage device 1 to execute the step S01 to the step S06 through the control board 15. There is no strict order for the step S01 to the step S06. For example, the step S03 or the step S05 may be executed first.

The step S01 is turning on a vacuum pump of the negative pressure massage device. The step S02 is generating, by the vacuum pump, a first negative pressure value at an open end. When the vacuum pump 10 is turned on, the first negative pressure value 101 may be produced at the open end 16. That is, as mentioned above, the first negative pressure value 101 is the difference value between the atmospheric pressure of the environment and the pressure at the open end 16. When the vacuum pump 10 is turned on, the first negative pressure value 101 is a positive value. When the pressure at the open end 16 is smaller, the first negative pressure value 101 is larger. When the vacuum pump 10 is turned off, the pressure at the open end 16 is the same as the ambient atmospheric pressure. Of course, depending on different definitions, the negative pressure value may also be a negative value, here is not intended to be limiting.

The step S03 is turning on a first solenoid valve of the negative pressure massage device. The step S04 is generating, by the first solenoid valve, a first flow and generating a second negative pressure value at the open end. When the first solenoid valve 11 is turned on, the air (or gas) outside the negative pressure massage device 1 may flow in through the first solenoid valve 11. As a result, the second negative pressure value 112 is generated at the open end 16. That is, the amount of air flowing into the first solenoid valve 11 per unit time, is the first flow 111. Since the air flowing into the first flow 111 causes the negative pressure value to decrease, the second negative pressure value 112 is less than the first negative pressure value 101.

The step S05 is turning on a second solenoid valve of the negative pressure massage device. The step S06 is generating, by the second solenoid valve, a second flow and generating a third negative pressure value at the open end. When the second solenoid valve 12 is turned on, the air outside the negative pressure massage device 1 may flow in through the second solenoid valve 12. As a result, the third negative pressure value 122 at the open end 16 may be adjusted. That is, the amount of air flowing into the second solenoid valve 12 per unit time, is the second flow 121. Since the air flowing into the second flow 121 causes the negative pressure value to decrease, the third negative pressure value 122 is less than the second negative pressure value 112. In some embodiments, the first flow 111 is equal to the second flow 121.

It is worth mentioning that, when the first solenoid valve 11 and the second solenoid valve 12 are turned on or turned off, the vacuum pump 10 communicates with the open end 16, and the vacuum pump 10 is configured to maintain a turn-on state. The vacuum pump 10 may remain communicating to the open end 16 and continue to operate, regardless of whether the first solenoid valve 11 and the second solenoid valve 12 are turned on or turned off.

Through different combinations of these steps, many different patterns may be derived. For example, by turning on the vacuum pump 10 for a period of time, then turning on the first solenoid valve 11. After a period of time, then turning off the first solenoid valve 11. In other words, change the negative pressure value at the open end 16 from the first negative pressure value 101 to the second negative pressure value 112, and finally change the negative pressure value back to the first negative pressure value 101. That is, the negative pressure values vary from large to small to large.

For another example, by turning on the vacuum pump 10 for a period of time, then turning on the first solenoid valve 11 for a period of time, then turning on the second solenoid valve 12 for a period of time, then simultaneously turning off the first solenoid valve 11 and the second solenoid valve 12. Therefore, the negative pressure value at the open end 16 change from the first negative pressure value 101 to the second negative pressure value 112, and then to the third negative pressure value 122, and then change back to the first negative pressure value 101, causing the negative pressure value to change from large to small to smaller and then to large. Other modes may be deduced in the same way and do not be described again here.

The first negative pressure value 101 is the difference value between the atmospheric pressure of the environment and the pressure at the open end 16. When the vacuum pump 10 is turned on, the first negative pressure value 101 is a positive value. When the pressure at the open end 16 is smaller, the first negative pressure value 101 is larger. When the vacuum pump 10 is turned off, the pressure at the open end 16 is the same as the ambient atmospheric pressure.

Furthermore, the opening time of the vacuum pump 10, the first solenoid valve 11, or the second solenoid valve 12 is more than 0 seconds and equal to or less than 9.9 seconds. The negative pressure value generated by the vacuum pump 10 is between 40 Torr and 600 Torr. The negative pressure value is the difference between the ambient atmospheric pressure and the pressure at the open end 16. When the vacuum pump 10 is turned on, the negative pressure value is positive. For example, when the pressure at the open end 16 is smaller, the negative pressure value is larger.

In the using method described in the present disclosure, if the continuous turn-on time of the vacuum pump 10 is X, and the intermittent turn-on time of the first solenoid valve 11 or the second solenoid valve 12 is Y (X and Y are independent of the time axis and do not affect each other), then the negative pressure massage device 1 may have the following recommended implementation methods according to the parts of the human body being massaged:
(1) chest: X=2.0˜2.4 seconds, Y=0.6˜1.0 seconds;
(2) hips: X=2.4˜3.0 seconds, Y=0.6˜1.5 seconds;
(3) shoulder and neck: X=2.2˜2.4 seconds, Y=0.6˜1.2 seconds or X=2.2˜2.4 seconds, Y=0.6˜1.2 seconds;
(4) abdomen: X=1.6˜2.4 seconds, Y=0.6˜1.0 seconds;
(5) face: X=2.2˜2.4 seconds, Y=0.6˜1.2 seconds or X=0.1˜0.2 seconds, Y=0.1˜0.2 seconds;
(6) female private part: X=0.1˜0.2 seconds, Y=0.1˜0.2 seconds.

FIG. 3A and FIG. 3B are the step chart diagrams of the using method of the negative pressure massage device in accordance with the present disclosure. Please refer to FIG. 3B, the step S01 is turning on a vacuum pump of the negative pressure massage device. The step S02 is generating, by the vacuum pump, a first negative pressure value at an open end. The step S03 is turning on a first solenoid valve of the negative pressure massage device. The step S04 is generating, by the first solenoid valve, a first flow and generating a second negative pressure value at the open end. The step S05 is turning on a second solenoid valve of the negative pressure massage device. The step S06 is generating, by the second solenoid valve, a second flow and generating a third negative pressure value at the open end. The step S07 is turning on a third solenoid valve of the negative pressure massage device. The step S08 is generating, by the third solenoid valve, a third flow and generating a fourth negative pressure value at the open end.

Please refer to FIG. 2 and FIG. 3B, before the step S01, the user first turns on the main power of the negative pressure massage device 2. Next, the user may control the negative pressure massage device 2 to execute steps S01 to step S08 through the control board 15. There is no strict order for the step S01 to the step S08. For example, the step S03, the step S05, or the step S07 may be executed first.

The step S07 is turning on a third solenoid valve of the negative pressure massage device. The step S08 is generating, by the third solenoid valve, a third flow and generating a fourth negative pressure value at the open end. When the third solenoid valve 13 is turned on, the air outside the negative pressure massage device 2 may flow in through the third solenoid valve 13. As a result, the fourth negative pressure value 132 is generated at the open end 16. That is, the amount of air flowing into the third solenoid valve 13 per unit time, is the third flow 131. Since the air flowing into the third flow 131 causes the negative pressure value to decrease, the fourth negative pressure value 132 is less than the third negative pressure value 122. In some embodiments, the first flow 111, the second flow 121, and the third flow 131 are equal to one another.

When the first solenoid valve 11, the second solenoid valve 12, and the third solenoid valve 13 are turned on or turned off, the vacuum pump 10 communicates with the open end 16, and the vacuum pump 10 is configured to maintain a turn-on state. The vacuum pump 10 may remain communicating to the open end 16 and continue to operate, regardless of whether the first solenoid valve 11, the second solenoid valve 12, and the third solenoid valve 13 are turned on or turned off.

Through different combinations of these steps, many different patterns may be derived. For example, by turning on the vacuum pump 10, after a period of time, then turning on the first solenoid valve 11, after a period of time, then turning on the second solenoid valve 12, after a period of time, then turning on the third solenoid valve 13. After a period of time, then simultaneously turning off the first solenoid valve 11, the second solenoid valve 12, and the third solenoid valve 13, and then turning off the vacuum pump 10. Therefore, the negative pressure value at the open end 16 changes from the first negative pressure value 101 to the second negative pressure value 112 to the third negative pressure value 122 and then to the fourth negative pressure value 132 and then changes back to the first negative pressure value 101, and finally changes the negative pressure value to zero. That is the negative pressure value changes with time. Other modes may be deduced in the same way and do not be described again here.

In summary, comparing the negative pressure massage device and using method thereof of the present disclosure with the negative pressure massage equipment of the related-art, the negative pressure massage equipment of the related-art is difficult to optimally adapt to different parts of the human body and difficult to adapt to different massage targets, such as the elderly and children, men and women, etc. The negative pressure massage device and using method thereof of the present disclosure, the user may first place the cup body on the part to be massaged, and then turn on the main power of the negative pressure massage device.

Next, the control unit may be used to control the turning on of the vacuum pump according to the control parameters stored in the storage unit. The control unit controls the turning on or turning off the first solenoid valve, the second solenoid valve, the third solenoid valve, and the fourth solenoid valve. The storage unit may store a plurality of modes.

The control unit may turn on or off any one, any two, any three, or all of the first solenoid valve, the second solenoid valve, the third solenoid valve, and the fourth solenoid valve over time by enabling different modes, to control flow to achieve more diverse negative pressures, which is changing over time, and achieve different massage effects and purposes. Further, the technical problem in the related-art of difficult to optimally adapting to the massage status of various parts of the human body or the object being massaged may be solved, and the purpose of saving costs and improving usage efficiency may also be achieved. Furthermore, the operation method of the negative pressure massage device of the present disclosure, may be simplified by making the first flow, the second flow, the third flow, and the fourth flow be equal to one another. For example, the user does not need to adjust the flow rate of each solenoid valve, and may simply turn on or turn off each solenoid valve to combine different flow requirements.

In addition, regardless of whether the first solenoid valve, the second solenoid valve, the third solenoid valve, and the fourth solenoid valve are turning on or turning off, the vacuum pump may remain communicating to the open end and continuing to operate. That may avoid the vacuum pump from generating the negative pressure at the open end when the vacuum pump is turned on, and result in energy waste. Moreover, by disposing of the cup body may adapt to the shape of the human body, making the massage process more comfortable. Through various modes predetermined in the storage unit, the user may choose the mode that best suits the user to make the massage process more comfortable.

While this disclosure has been described by means of specific embodiments, numerous modifications and variations may be made thereto by those skilled in the art without departing from the scope and spirit of this disclosure set forth in the claims.

What is claimed is:

1. A negative pressure massage device comprising:
a vacuum pump, communicating to an open end;
a first solenoid valve, communicating to the vacuum pump and the open end;
a second solenoid valve, communicating to the vacuum pump, the open end, and the first solenoid valve;
a third solenoid valve, communicating to the vacuum pump, the open end, the first solenoid valve, and the second solenoid valve; and
a control board, electrically connected to the vacuum pump, the first solenoid valve, the second solenoid valve, and the third solenoid valve;
wherein, when any one of the first solenoid valve, the second solenoid valve, and the third solenoid valve is turned on, the vacuum pump is configured to maintain a communicating with the open end.

2. The negative pressure massage device of claim 1, wherein, when the first solenoid valve is turned on and the second solenoid valve and the third solenoid valve are turned off, the vacuum pump is configured to maintain the communicating with the open end.

3. The negative pressure massage device of claim 1, wherein, when the first solenoid valve and the second solenoid valve are turned on and the third solenoid valve is turned off, the vacuum pump is configured to maintain the communicating with the open end.

4. The negative pressure massage device of claim 1, wherein, when the first solenoid valve, the second solenoid valve, and the third solenoid valve are turned on simultaneously, the vacuum pump is configured to maintain the communicating with the open end.

5. The negative pressure massage device of claim 3, wherein, a first flow, which is generated when the first solenoid valve is turned on, is equal to a second flow, which is generated when the second solenoid valve is turned on.

6. The negative pressure massage device of claim 4, wherein, the first flow, the second flow, and a third flow, which is generated when the third solenoid valve is turned on, are equal to one another.

7. The negative pressure massage device of claim 1, further comprising:
a fourth solenoid valve, communicating to the vacuum pump, the open end, the first solenoid valve, the second solenoid valve, and the third solenoid valve, and electrically connected to the control board;
wherein, when the first solenoid valve, the second solenoid valve, the third solenoid valve, and the fourth solenoid valve are turned on simultaneously, the vacuum pump is configured to maintain the communicating with the open end.

8. The negative pressure massage device of claim 7, wherein, the first flow, the second flow, the third flow, and a fourth flow, which is generated when the fourth solenoid valve is turned on, are equal to one another.

9. A negative pressure massage device comprising:
a vacuum pump, communicating to an open end;
a first solenoid valve, communicating to the vacuum pump and the open end;
a second solenoid valve, communicating to the vacuum pump, the open end, and the first solenoid valve;
a third solenoid valve, communicating to the vacuum pump, the open end, the first solenoid valve, and the second solenoid valve; and
a control board, electrically connected to the vacuum pump, the first solenoid valve, the second solenoid valve, and the third solenoid valve;
wherein, the vacuum pump, the first solenoid valve, the second solenoid valve, and the third solenoid valve are parallelly disposed with one another.

10. The negative pressure massage device of claim 9, wherein, when the first solenoid valve is turned on and the second solenoid valve and the third solenoid valve are turned off, the vacuum pump is configured to maintain a communicating with the open end.

11. The negative pressure massage device of claim 9, wherein, when the first solenoid valve and the second solenoid valve are turned on and the third solenoid valve is turned off, the vacuum pump is configured to maintain the communicating with the open end.

12. The negative pressure massage device of claim 9, wherein, when the first solenoid valve, the second solenoid valve, and the third solenoid valve are turned on simultaneously, the vacuum pump is configured to maintain the communicating with the open end.

13. The negative pressure massage device of claim 9, wherein, a first flow, which is generated when the first solenoid valve is turned on, is equal to a second flow, which is generated when the second solenoid valve is turned on.

14. The negative pressure massage device of claim 13, wherein, the first flow, the second flow, and a third flow, which is generated when the third solenoid valve is turned on, are equal to one another.

15. The negative pressure massage device of claim 9, further comprising:
a fourth solenoid valve, communicating to the vacuum pump, the open end, the first solenoid valve, the second solenoid valve, and the third solenoid valve, and electrically connected to the control board;
wherein, when the first solenoid valve, the second solenoid valve, the third solenoid valve, and the fourth solenoid valve are turned on simultaneously, the vacuum pump is configured to maintain the communicating with the open end.

16. The negative pressure massage device of claim 15, wherein, the first flow, the second flow, the third flow, and a fourth flow, which is generated when the fourth solenoid valve is turned on, are equal to one another.

17. A using method of a negative pressure massage device, the using method comprising:
turning on a vacuum pump of the negative pressure massage device;
generating, by the vacuum pump, a first negative pressure value at an open end;
turning on a first solenoid valve of the negative pressure massage device;
generating, by the first solenoid valve, a first flow and generating a second negative pressure value at the open end;
turning on a second solenoid valve of the negative pressure massage device; and
generating, by the second solenoid valve, a second flow and generating a third negative pressure value at the open end;
wherein, the first flow is equal to the second flow.

18. The using method of claim 17, wherein, when the first solenoid valve and the second solenoid valve are turned on or turned off, the vacuum pump communicates with the open end, and the vacuum pump is configured to maintain a turn-on state.

19. The using method of claim 17, further comprising:
turning on a third solenoid valve of the negative pressure massage device; and
generating, by the third solenoid valve, a third flow and generating a fourth negative pressure value at the open end;
wherein, the first flow, the second flow, and the third flow are equal to one another.

20. The using method of claim 19, wherein, when the first solenoid valve, the second solenoid valve, and the third solenoid valve are turned on or turned off, the vacuum pump communicates with the open end, and the vacuum pump is configured to maintain a turn-on state.
